(19) United States
(12) Patent Application Publication
(10) Pub. No.: US 2006/0064277 A1
(43) Pub. Date: Mar. 23, 2006

(54) Exercise amount measuring method using mobile communication terminal

(75) Inventors: Mun Ho Jung, Gyeonggi-do (KR); Dong Hoon Yi, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/202,599

(22) Filed: Aug. 11, 2005

(30) Foreign Application Priority Data
Aug. 17, 2004 (KR) 2004-0064537

(51) Int. Cl. G06F 15/00

(52) U.S. Cl. 702/160

(57) ABSTRACT

An exercise amount measuring method using a mobile communication terminal is provided whereby an amount of such exercise as mountain climbing, walking, jogging or the like can be measured through the use of a mobile communication terminal capable of self-reliant navigation. The method comprises the steps of; determining an exercise route which a user has covered from a start position to a current position with a central processing unit; dividing the determined exercise route into a plurality of route segments; calculating a reference exercise amount based on a length of each divided route segment; multiplying the reference exercise amount calculated by a predetermined weighting value to calculate an actual exercise amount for each route segment; and summing up all the exercise amounts calculated for the route segments to reckon and display a total amount of exercise.

### CROSS REFERENCE TO RELATED APPLICATIONS

Pursuant to 35 U.S.C. § 119(a), this application claims the benefit of earlier filing date and right of priority to Korean Patent Application No. 10-2004-0064537, filed on Aug. 17, 2004, the content of which is hereby incorporated by reference herein in its entirety.

### FIELD OF THE INVENTION

The present invention is directed to an exercise amount measuring method using a mobile communication terminal whereby an amount of such exercises as mountain climbing, walking, jogging and the like can be measured through the use of a mobile communication terminal with the capability of stand-alone navigation.

### BACKGROUND OF THE INVENTION

A need has existed for low and medium priced navigation systems along with the development of navigation message-based position acquisition technologies and the growth of telematics system industry using multimedia system in mobile objects such as an automotive vehicle and the like.

The conventional navigation system is provided with a position acquisition module capable of acquiring information on a current position of a mobile object, a travel route calculation module for calculating a travel route of the mobile object and a travel route guidance module that serves to guide the mobile object along the calculated travel route.

In order to provide supplementary services including traffic information service, the navigation system makes use of broadcasting waves of a Digital Multimedia Broadcasting (DMB) and a Frequency Modulation Broadcasting (FMB) or such mobile communication means as a Code Division Multiple Access system (CDMA) and a Global System for Mobile communication (GSM).

Since an interactive communication is inherently impossible with the broadcasting waves, it is inevitable for the navigation system to use communication means such as CDMA and GSM enabling the interactive communication. However, modems for use in CDMA or GSM are quite costly and hence impose a heavy financial burden in developing low and medium priced navigation systems.

As a solution to this problem, it has been proposed that a navigation system capable of self-reliant navigation is integrally built in a mobile communication terminal that an increasing number of users use in recent years. If needed, for instance, when a mobile object is caused to move, the user can operate the navigation system built in the mobile communication terminal to acquire guidance information on a travel route from a current position to an intended destination.

The navigation system built in the mobile communication terminal is however currently used for the sole purpose of guiding the travel route of the mobile object and the function that the navigation system plays is quite limited.

In the meantime, physical activities of people tend to be reduced along with the improvement in their living environments and the number of patients who suffer from a variety of adult diseases, e.g., obesity, is steadily increased due to lack of exercise. This motivates a great number of people to do such an exercise as mountain climbing, walking or jogging in their spare time.

Physical exercises have to be done properly in conformity with a body condition of an exerciser. Doing an immoderate exercise may sometimes injure the health. For that reason, it would be desirable to measure and learn an exercise amount when one does an exercise such as mountain climbing, walking or jogging.

A step counter (a.k.a., a ten thousand step counter) is widely known as one of the devices for measuring an exercise amount. The step counter is designed to increase a count each time the user walks along, thereby permitting the user to measure the number of steps for a given period of walking time.

Due to the fact that the step counter is solely designed to count the number of walking steps, it cannot measure the exercise amount at a time when such an exercise as mountain climbing, walking, jogging or the like is done.

### SUMMARY OF THE INVENTION

Accordingly, it is an object of the present invention to provide an exercise amount measuring method using a mobile communication terminal that allows an amount of exercise such as mountain climbing, walking, jogging or the like to be measured through the use of the mobile communication terminal capable of self-reliant navigation.

Another object of the present invention is to provide an exercise amount measuring method using a mobile communication terminal that can measure an exercise amount in a precise manner based on a distance a user covered, a road gradient, a road condition, an environmental condition and a moving speed of the user.

With these objects in view, determination is first made to learn an exercise route along which a user has covered. The exercise route can be accurately determined from a current position of the user in response to navigation signals a global positioning system receiver (hereinafter referred to as “GPS receiver”) receives based on navigation messages. In addition to the signals of the GPS receiver, signals detected by a terrestrial magnetism sensor and a speed detector are used for said determination.

Once the exercise route is determined, gradient and road conditions of the exercise route are judged by use of a map data, and the exercise route is then divided into a plurality of route segments depending on the road gradient and the road condition thus judged.

A reference amount of exercise corresponding to a length of each route segment is calculated with respect to each divided route segment. The reference exercise amount is multiplied by a weighting value to calculate an actual amount of exercise for each route segment, wherein the weighting value is predetermined depending on a factor affecting the amount of exercise, namely, a road gradient, a road condition, an ambient temperature, an atmospheric pressure, a humidity and a moving speed. The actual exercise amounts calculated for each route segment are summed up to add up a total exercise amount, which in turn is displayed on a display part so that the user can check the exercise amount done.

In accordance with the object of the present invention, there is provided an exercise amount measuring method with the use of a mobile communication terminal, comprising the steps of; determining an exercise route along which a user has covered from a start position to a current position with a central processing unit; dividing the determined exercise route into a plurality of route segments; calculating an exercise amount with respect to each divided route segment; and summing up all the exercise amounts calculated for the route segments to reckon and display a total amount of exercise.

The measurement of the exercise amount is executed when a command of measurement is inputted from a command input part.

The exercise route is determined based on a position detected by a GPS receiver that receives navigation messages, an azimuth angle judged from output signals of a terrestrial magnetism sensor, and a moving speed detected by a speed detector part.

The plural exercise route dividing step comprises: reading out a map data stored at a map storage part to acquire a gradient and a road condition associated with the exercise route; and dividing the exercise route into a plurality of route segments depending on the gradient and the road condition acquired.

The exercise amount calculating step comprises: acquiring a factor affecting the exercise amount with respect to each divided route segment; and calculating the exercise amount based on the acquired factor on a segment-by-segment basis, wherein the factor affecting the exercise amount is at least one of the following elements which are a distance of movement, a road gradient, a road condition, an ambient temperature, an atmospheric pressure, a humidity, each associated with the respective route segments, and a moving speed of the user.

The exercise amount calculating step comprises: calculating a reference exercise amount based on a length of each divided route segment and then calculating an actual exercise amount for each route segment by multiplying the reference exercise amount calculated and a predetermined weighting value depending on a factor that affects the amount of exercise, wherein the factor affecting the exercise amount is at least one of the following elements which are a gradient, a road condition, an ambient temperature, an atmospheric pressure, a humidity and a moving speed of the user.

The invention further comprises the steps of: judging whether the exercise has been finished; and terminating measurement of the exercise amount if the exercise is judged to be finished, wherein the judging step comprises: deciding whether the user moves or not; and judging the exercise to have been finished if it is decided that the user stops movement for a predetermined period of time or if the user inputs a command to finish measuring the exercise amount through a command input part.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram showing a mobile communication terminal to which an exercise amount measuring method according to the present invention is applied;

FIG. 2 is a flowchart illustrating an exercise amount measuring method according to the present invention; and

FIG. 3 is a flowchart illustrating a process of measuring an actual exercise amount for each route segment in the method shown in FIG. 2.

### DETAILED DESCRIPTION OF THE INVENTION

Now, a preferred embodiment of an exercise amount measuring method with the use of a mobile communication terminal according to the present invention will be set forth in detail with reference to the attached drawings.

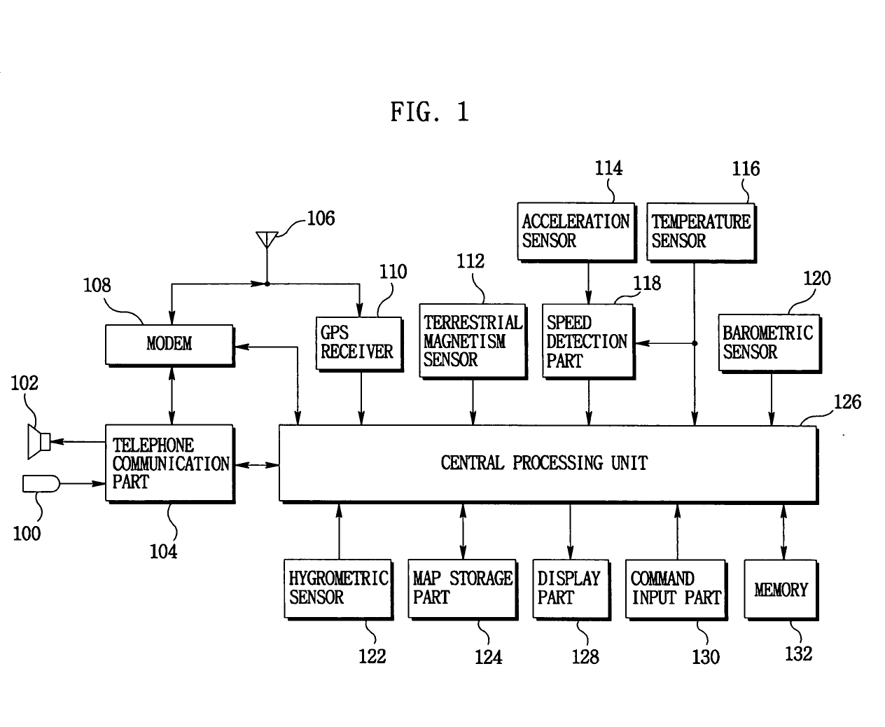

Referring to FIG. 1, there is shown a block diagram of a mobile communication terminal to which an exercise amount measuring method according to the present invention is applied. In the figure, reference numeral 100 denotes a microphone, with a speaker and a communication part designated by 102 and 104, respectively. The communication part 104 enables a user to conduct a telephone communication by allowing the user to input his or her voice signals through the microphone 100 and outputting the other party's voice signals through the speaker 102.

Reference numeral 106 designates an antenna and reference numeral 108 indicates a modem that demodulates voice signals of the other party received from the antenna 106 and then feed the demodulated voice signals to the communication part 104, while modulating the user's voice signals issued from the communication part 104 and then transmitting the modulated voice signals through the antenna 106.

Designated by reference numeral 110 is a GPS receiver that, through the antenna 106, receives at least four of navigation messages periodically transmitted from a plurality of earth-orbiting GPS satellites and detects a current position of a mobile communication terminal or a user holding the same.

Reference numeral 112 designates a terrestrial magnetism sensor that can detect a terrestrial magnetism and find an azimuth angle of a mobile communication terminal based on the terrestrial magnetism detected. Reference numeral 114 indicates an acceleration sensor that detects an acceleration of a mobile communication terminal as it moves, reference numeral 116 designating a temperature sensor for detecting an ambient temperature around a mobile communication terminal and reference numeral 118 designating a speed detection part for detecting a speed at which a mobile communication terminal moves. The speed detection part 118 compensates the acceleration signals detected by the acceleration sensor 114 in response to the temperature that the temperature sensor 116 detects, and hence detect a moving speed of the mobile communication terminal by integrating and accumulating the compensated acceleration signals.

Reference numeral 120 denotes a barometric sensor that detects an atmospheric pressure around a mobile communication terminal, reference numeral 122 indicating a hygrometric sensor for detecting a humidity in the surroundings of a mobile communication terminal and reference numeral 124 indicating a map storage part at which a map data is stored in advance.

Reference numeral 126 designates a central processing unit 126 that controls the communication part 104 and the modem 108 such that a user can make a telephone communication. The central processing unit 126 also determines a current position of a mobile communication terminal based on the detection signals issued from the GPS receiver 110, the azimuth angle detected by the terrestrial magnetism sensor 112 and the moving speed detected by the speed detection part 118. The current position of the mobile communication terminal thus determined is matched to the map data stored at the map storage part 124 and then displayed under the control of the central processing unit 126. It is also the role of the central processing unit 126 to determine the ambient temperature, the atmospheric pressure and the humidity respectively detected by the temperature sensor 116, the barometric sensor 120 and the hygrometric sensor 122. In addition, the central processing unit 126 determines the exercise route along which the user has moved for exercise, measures an exercise amount done by the user based on a distance of movement, a road gradient, a road condition, a moving speed, an ambient temperature, an atmospheric pressure and a humidity of the determined exercise route. The exercise amount thus measured is displayed under the control of the central processing unit 126.

Reference numeral 128 designates a display part that functions to display a telephone communication status, a map to which the current position and the azimuth angle of a mobile communication terminal are matched, and the exercise amount under the control of the central processing unit 126.

Reference numeral 130 designates a command input part through which a command of a user is inputted into the central processing unit 126, and reference numeral 132 designates a memory that temporarily stores a data processed by the central processing unit 126.

With the inventive mobile communication terminal as set forth above, if a user gives a command to execute a telephone communication through manipulation of the command input part 130, the central processing unit 126 controls the telephone communication part 104 and the modem 108 in such a manner that the user can perform the intended telephone communication. More specifically, under the control of the central processing unit 126, the voice signals of the user are inputted through the microphone 100, processed in the telephone communication part 104, modulated in the modem 108 and transmitted through the antenna 106. The voice signals of the other party received through the antenna 106 are demodulated by the modem 108, processed in the telephone communication part 104 and outputted through the speaker 102, thereby enabling the user to make a telephone communication.

When a user carrying a mobile communication terminal inputs a command to provide a navigation service by manipulating the command input part 130 of the mobile communication terminal, the central processing unit 126 determines a current position of a mobile object, i.e., the mobile communication terminal, based on the output signals of the GPS receiver 110. In other words, the GPS receiver 110 receives navigation messages transmitted from at least four of the plurality of earth-orbiting GPS satellites and detects the position where the navigation messages are received, thus ensuring that the central processing unit 126 can determine the current position of the mobile object based on the position detected by the GPS receiver 110.

The central processing unit 126 determines an azimuth angle of the mobile object in response to the detection signals of the terrestrial magnetism sensor 112. Specifically, the terrestrial magnetism sensor 112 detects the terrestrial magnetism and provides the detection signals to the central processing unit 126 so that it can determine the azimuth angle of the mobile object.

The central processing unit 126 discriminates a travel speed of the mobile object based on the output signals of the speed detection part 118. To be more specific, the acceleration sensor 114 detects an acceleration of the mobile object and the temperature sensor 116 detects an ambient temperature. In response, the speed detection part 118 compensates the acceleration signals received from the acceleration sensor 114 in response to the temperature detected by the temperature sensor 116, integrates the compensated acceleration signals and accumulates the integrated values to thereby detect a speed of the mobile object. The central processing unit 126 judges the speed detected by the speed detection part 118 to be a moving speed of the mobile object.

Moreover, the central processing unit 126 reads out, from the map storage part 124, the map data for a given area around the current position of the mobile object detected by the GPS receiver 110. If the map data is read out, the central processing unit 126 determines the current position of the mobile object based on the output signals of the GPS receiver 110, the terrestrial magnetism sensor 112 and the speed detection part 118, and causes the determined current position to be matched to the map data. Specifically, the GPS receiver 110 receives the navigation messages at a time interval of about 1 second to detect the current position of the mobile object, while the terrestrial magnetism sensor 112 and the speed detection part 118 detect the terrestrial magnetism and the moving speed on a real time basis. As the GPS receiver 110 generates the detection signals indicative of the current position of the mobile object, the central processing unit 126 matches the detected current position to the map data. In a case that the GPS receiver 110 generates no detection signal, the central processing unit 126 estimates the current position of the mobile object based on the output signals of the terrestrial magnetism sensor 112 and the speed detection part 118, and matches the estimated current position of the mobile object to the map data.

Once the current position of the mobile object is matched to the map data in this fashion, the central processing unit 126 prompts the map data and the current position of the mobile object to be displayed on the display part 128 so that the user can check the current position.

In the meantime, if the user wishes to measure the exercise amount while doing such exercise as mountain climbing, walking or jogging, it is required that the user should first input a command to execute the measurement via manipulation of the command input part 130.

Responsive to said command input, the central processing unit 1.26 determines the current position of the user based on the output signals of the GPS receiver 110 and then determines the exercise route along which the user has moved, based on the current position determined above.

If the determination of the exercise route is completed, the central processing unit 126 determines a road gradient and a road condition of the exercise route by way of the map data stored at the map storage part 124 and divides the exercise route into a plurality of route segments depending on the gradient and the road condition determined.

Subsequently, the central processing unit 126 calculates a unit exercise amount with respect to each divided route segment by using an average moving speed of the user and average environmental information such as an average ambient temperature, an average humidity, an average atmospheric pressure and the like. The unit exercise amounts calculated for the entire route segments are summed up to acquire a total exercise amount, which is displayed on the display part 128 for the user to check.

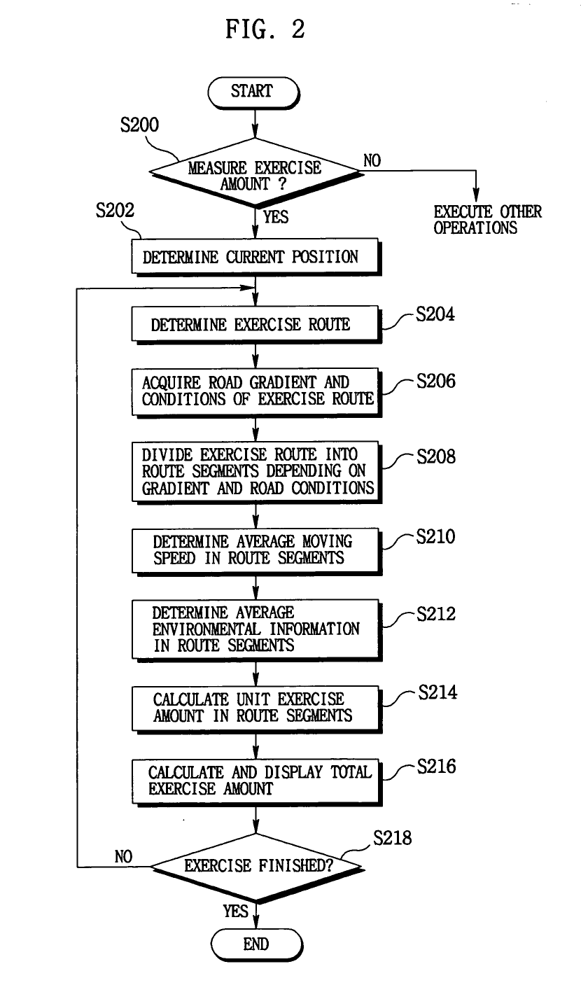

Referring to FIG. 2, if a user inputs a command to conduct the measurement of the exercise amount through the manipulation of the command input part 130 at S200, the central processing unit 126 determines, at S202, a current position of the mobile communication terminal, i.e., a current position of the user holding the mobile communication terminal, in response to the output signals of the GPS receiver 110.

At S204, the central processing unit 126 determines an exercise route along which the user has moved for exercise, in response to the output signals from the GPS receiver 110, the terrestrial magnetism sensor 112 and the speed detection part 118. At S206, a road gradient and a road condition of the determined exercise route are acquired from the map data stored at the map storage part 124.

At S208, the central processing unit 126 divides the exercise route of the user into a plurality of route segments depending on the gradient and the road condition acquired. Specifically, the exercise amount in the exercise route varies with the road gradient and depends on the road condition, e.g., whether paved, unpaved or white sandy beach. According to the instant invention, therefore, the road gradient of the exercise route is subdivided into −10°˜−6°, −5°˜−1°, 0°, 1°˜5° and 6°˜10°, for instance, while the road condition is subdivided into a paved road, an unpaved road and a white sandy beach, to name some.

At S210, the central processing unit 126 determines an average moving speed at each route segment in response to the output signals of the GPS receiver 110, the terrestrial magnetism sensor 112 and the speed detection part 118, and at S212, determines average environmental information for each route segment. The determination of the average environmental information is made by virtue of accumulating the ambient temperature, the atmospheric pressure and the humidity respectively detected by the temperature sensor 116, the barometric sensor 120 and the hygrometric sensor 122, and then acquiring an average ambient temperature, an average atmospheric pressure and an average humidity.

At S214, the central processing unit 126 calculates a unit exercise amount for each route segment, based on the distance, the road gradient, and the road condition of the respective route segments, the average moving speed and the average environmental information. At S216, the central processing unit 126 calculates a total exercise amount by accumulating the unit exercise amounts calculated for the respective route segments, whose total exercise amount is displayed on the display part 128 for the user to check.

At S218, it is judged whether the user has finished the exercise. This judgment step is carried out, e.g., by deciding whether the user has moved or not, and judging that the exercise has been finished if it is decided that the user stops movement for a predetermined period of time. The exercise may be judged to have been finished in a case that the user inputs a command to finish measuring the exercise amount via a command input part 130.

If it is judged at S218 that the exercise has not been finished, flow returns back to S204, where the central processing unit 126 repeats the operations of determining the exercise route, measuring the unit exercise amount for the route segments, summing up the measured exercise amounts and displaying the total exercise amount. Measurement of the exercise amount is completed if the exercise is judged to have been finished.

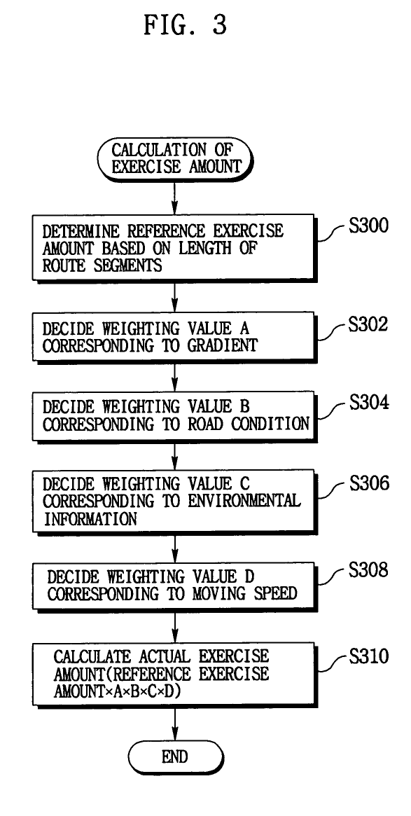

FIG. 3 is a flowchart illustrating a process of measuring an actual exercise amount for each route segment at S214 shown in FIG. 2. As illustrated, the central processing unit 126 calculates, at S300, a reference exercise amount based on the length of each route segment. The reference exercise amount is proportional to the moved distance of the user and calculated in correspondence to the length of the respective route segments.

At S302, the central processing unit 126 decides a weighting value A that depends on the road gradient of each route segment. For instance, the weighting value A is set at 0.5 if the road gradient is in the range of −10°˜−6°, 0.8 if the gradient is in the range of −5°˜−1°, 1 if the gradient is equal to 0°, 1.2 if the gradient is in the range of 1°˜5°, and 1.4 if the gradient is in the range of 6°˜10°. In this fashion, the central processing unit 126 decides the weighting value A based on the road gradient of each route segment.

At S304, the central processing unit 126 decides a weighting value B that depends on the road condition of each route segment. For example, the weighting value B is set at 1 if a route segment amounts to a paved road, 1.2 if a route segment amounts to an unpaved road, and 1.4 if a route segment amounts to a white sandy beach. In this fashion, the central processing unit 126 decides the weighting value B based on the road condition of each route segment.

At S306, the central processing unit 126 decides a weighting value C that depends on the environmental information determined in the foregoing. For instance, the weighting value C is set at a higher value if the ambient temperature, the atmospheric pressure and the humidity are higher than those of pleasant feeling state but to a lower value if the ambient temperature, the atmospheric pressure and the humidity are lower than those of the pleasant feeling state. In this manner, the central processing unit 126 decides the weighting value C based on the environmental information of the exercise route.

At S308, the central processing unit 126 decides a weighting value D that depends on the moving speed of the user. For instance, the weighting value D is set at 1 if the user moves at a normal speed as in a walking, greater than 1 if the user moves fast as in a jogging, and smaller than 1 if the user moves more slowly than the normal speed. In this fashion, the central processing unit 126 decides the weighting value D based on the moving speed of the user.

Once the reference exercise amount corresponding to the length of the respective route segment, the weighting value A corresponding to the gradient of the respective route segment, the weighting value B corresponding to the road condition of the respective route segment, the weighting value C corresponding to the environmental information and the weighting value D corresponding to the moving speed of the user are decided in this manner, the central processing unit 126 calculates, at S3 10, an actual exercise amount on a segment-by-segment basis by multiplying the reference exercise amount by the weighting values A, B, C, D. The actual exercise amounts calculated for the entire route segment are summed up and displayed on the display part 128 at S216.

Although a preferred embodiment of the present invention has been shown and described in the foregoing, it will be apparent to those skilled in the art that various changes or modifications may be made thereto within the scope of the invention defined by the appended claims. For example, although the exercise amount is calculated in the foregoing by taking into account the entire factor including the road gradient, the road condition, the distance of the exercise route, the ambient temperature, the atmospheric pressure, the humidity and the moving speed of the user, it would be possible that at least one of these factors is used in calculating the exercise amount. Furthermore, the exercise amount may be calculated by establishing an exercise route in advance and detecting the average moving speed of the user, the current ambient temperature, the atmospheric pressure and the humidity in the established route of exercise.

As apparent from the foregoing, when a user is doing an exercise, a mobile communication terminal capable of self-reliant navigation determines an exercise route along which the user has moved, the moving speed, the gradient, the road condition, the environmental information and the like, measures the exercise amount of the user and displays the measured exercise amount, whereby the user can check at any time the exercise amount when mounting climbing, walking, jogging or the like exercise is done by the user, allowing the user to do a moderate exercise in conformity with his or her body condition.

What is claimed is:

1. An exercise amount measuring method using a mobile communication terminal, comprising the steps of:
determining an exercise route which a user has covered from a start position to a current position with a central processing unit;
dividing the determined exercise route into a plurality of route segments;
calculating an exercise amount with respect to each divided route segment; and
summing up all the exercise amounts calculated for the route segments to reckon and display a total amount of exercise.

2. The method as recited in claim 1, wherein the measurement of the exercise amount is executed when a command of measurement is inputted from a command input part.

3. The method as recited in claim 1, wherein, at the determining step, the exercise route is determined based on a position detected by a global positioning system receiver that receives navigation messages, an azimuth angle judged from output signals of a terrestrial magnetism sensor, and a moving speed detected by a speed detector part.

4. The method as recited in claim 1, wherein the dividing step comprises reading out a map data stored at a map storage part to acquire a road gradient and a road condition associated with the exercise route and dividing the exercise route into a plurality of route segments depending on the road gradient and the road condition acquired.

5. The method as recited in claim 1, wherein the calculating step comprises acquiring a factor affecting the exercise amount with respect to each divided route segment and calculating the exercise amount based on the acquired factor on a segment-by-segment basis.

6. The method as recited in claim 5, wherein the factor affecting the exercise amount is at least one selected from a group consisting of a distance, a road gradient, a road condition, an ambient temperature, an atmospheric pressure, a humidity, each associated with the respective route segment, and a moving speed of the user.

7. The method as recited in claim 1, wherein the calculating step comprises calculating a reference exercise amount based on a length of each divided route segment and then calculating an actual exercise amount for each route segment by multiplying the reference exercise amount calculated by a weighting value predetermined depending on a factor that affects the exercise amount.

8. The method as recited in claim 7, wherein the factor affecting the exercise amount is at least one selected from a group consisting of a road gradient, a road condition, an ambient temperature, an atmospheric pressure, a humidity and a moving speed of the user.

9. The method as recited in claim 1, further comprising the steps of: judging whether the exercise has been finished; and terminating measurement of the exercise amount if the exercise is judged to have been finished.

10. The method as recited in claim 9, wherein the judging step comprises the steps of: deciding whether the user has moved or not; and judging the exercise to have been finished if it is decided that the user stops movement for a predetermined period of time or if the user inputs a command to finish measuring the exercise amount through a command input part.

11. An exercise amount measuring method using a mobile communication terminal, comprising the steps of:
reading out a map data stored at a map storage part with a central processing unit to display the map data on a display part;
establishing an exercise route with the use of the displayed map data;
dividing the established exercise route into a plurality of route segments;
calculating an exercise amount with respect to each divided route segment; and
summing up all the exercise amounts calculated for the route segments to reckon and display a total amount of exercise.

12. The method as recited in claim 11, wherein the dividing step comprises: acquiring a road gradient and a road condition associated with the exercise route from the map data; and dividing the exercise route into a plurality of route segments depending on the road gradient and the road condition acquired.

13. The method as recited in claim 11, wherein the calculating step comprises calculating a reference exercise amount based on a length of each divided route segment and then calculating an actual exercise amount for each route segment by multiplying the reference exercise amount calculated by a weighting value predetermined depending on a factor that affects the amount of exercise.

14. The method as recited in claim 13, wherein the factor affecting the exercise amount is at least one selected from a group consisting of a road gradient, a road condition, an ambient temperature, an atmospheric pressure, a humidity and a moving speed of the user.
